(19) United States
(12) Patent Application Publication
(10) Pub. No.: US 2006/0207275 A1
(43) Pub. Date: Sep. 21, 2006

(54) CAB FOR A VEHICLE, VEHICLE WITH SUCH CAB AND METHOD AND DEVICE FOR CONTROLLING A CLOSED HEAT TRANSPORT SYSTEM

(75) Inventor: Bo JANELING, Eskilstuna (SE)

Correspondence Address: NOVAK DRUCE & QUIGG, LLP, 1300 EYE STREET NW, 400 EAST TOWER, WASHINGTON, DC, 20005, US

(73) Assignee: VOLVO CONSTRUCTION EQUIPMENT HOLDING SWEDEN AB, Eskilstuna (SE)

(21) Appl. No.: 11/423,439

(22) Filed: Jun. 10, 2006

Related U.S. Application Data
(63) Continuation of application No. PCT/SE04/01680, filed on Nov. 17, 2004.

(30) Foreign Application Priority Data
Dec. 10, 2003 (SE) 0303394-1
Nov. 1, 2004 (SE) 0402661-3

(51) Int. Cl. B60H 1/32; F25B 39/04

(52) U.S. Cl. 62/239; 62/509

(57) ABSTRACT

A cab (2) for a vehicle (1) including a roof (23) supported by a wall shell (22). The cab (2) bears a heat-evacuating device (3) having a fan and a condenser, the latter of which has a flat basic shape defined in general terms by two opposing large faces, and the condenser projects from the wall shell (22) with large faces thereof oriented at right angles to the wall shell (22).

### CROSS-REFERENCE TO RELATED APPLICATIONS

The present application is a continuation patent application of International Application No. PCT/SE2004/001680 filed 17 Nov. 2004 which is published in English pursuant to Article 21(2) of the Patent Cooperation Treaty and which claims priority to Swedish Application Nos. 0303394-1 filed 10 Dec. 2003 and 0402661-3 filed 1 Nov. 2004. Said applications are expressly incorporated herein by reference in their entireties.

### TECHNICAL FIELD

This invention relates to a vehicle cab comprising a roof supported upon a wall shell. The cab bears a heat-evacuating device comprising a fan and a condenser, the latter of which has a flat basic shape defined in general terms by two opposing large faces. The invention also relates to a vehicle provided with a cab of the disclosed type.

### BACKGROUND OF THE INVENTION

The present invention has its background in the need to transport heat out of the air in a driver's cab such as that disposed on a working machine or the like, and hence constitutes an operator work space/environment. During an ordinary work session, the vehicle is often unprotected from the sun since the majority of tasks for such a work vehicle is used are located in open spaces without any protective shade. Since the working environment around the vehicle is often noisy and dirty, it is usually not a comfortable option for the operator to carrying out his or her work with the doors of the driver's cab open. Owing to the nature of the work, a further problem with the working condition for the operator is that the driver's cab must have large windows to allow good visibility. The sun, combined with the conditions in the driver's cab (small and trapping the driver's body heat) and the working environment (also often hot), causes the temperature in the driver's cab to often rise as high as 50-60° C.

A generally recognized way of solving the abovementioned problems is to install an air- conditioning device in the vehicle. Such a device comprises a closed line system which transports a fluid between an evaporator located in the driver's cab, which absorbs heat from the air in the driver's cab, and a condenser situated outside the driver's cab, which releases heat into the ambient air.

EP 1,273, 467 shows a heat exchanger which is placed in the engine compartment of the vehicle in front of the vehicle engine, more precisely together with an engine-cooling system. A drawback with such a placement is that the very same air flow which passes through the heat exchanger also passes through a radiator located in the engine-cooling system. This air flow is created by a common fan, which thus has to endeavor to ensure that both the radiator of the engine and the heat exchanger will get sufficient air passing through them. The radiator and the heat exchanger often have different momentary requirements for cooling air (need the cooling air at different times) and therefore the cooling fan is consequently running more or less all of the time which is more than either of the radiator or heat exchanger independently require. It should also be noted that disruptions to engine-cooling capacity because of the heat exchanger(s) can result in a reduction in engine cooling effect and possibly cause damage to the engine itself.

The problem with the abovementioned placement, as is shown, inter alia, in U.S. Pat. No. 3,983,715, U.S. Pat. No. 4,098,093 and U.S. Pat. No. 4,567,734, has been solved by placing the heat exchanger in a place separated from the engine compartment of the vehicle. The two first-named publications, U.S. Pat. No. 3,983,715 and U.S. Pat. No. 4,098,093, show a heat exchanger which is placed up on the roof of the vehicle cab. This placement means that the vehicle is made taller, which is a clear drawback for vehicles in certain environments. The designs of the illustrated devices also mean that a severe diversion of the cooling air has to be made, resulting in power losses in the line system. Their designs also mean that dirt can easily block the air intake and or the actual heat exchanger. The last-named publication, U.S. Pat. No. 4,567,734, shows a device which is placed on the front side of a platform body disposed behind the driver's cab so as to make use of the air draught created during travel of the vehicle. In order to exploit the advantages of such a placement, the vehicle is required to move at a substantial speed. Normal use of a working machine means that such a speed is only exceptionally reached. As an example, front-loader working machines operate on short cycles of forward and return travel for the loading of gravel or the like.

It can generally be stated that, if the condenser is placed separated from the engine-cooling system, i.e. the condenser is isolated both functionally and physically from the engine-cooling system of the vehicle, problems can arise depending on where the condenser is in fact placed. The placement must allow sufficient air currents to flow to and from the condenser and the condenser must not disturb the view or be easily damageable by the surroundings of the vehicle. One drawback with placing a condenser with associated fan, operating on constantly high power (maximum power), on top of or on the side of the cab is that sound is easily transmitted into the cab.

### SUMMARY OF THE INVENTION

One object of the present invention is to eliminate the abovementioned drawbacks with previously known condenser placements and to present an improved solution. A fundamental object is to present a heat-evacuating device which projects transversely from a vehicle in order to ensure that the air flow passing through the heat-evacuating device is not disturbed by the rest of the vehicle design. A second object is to present a heat-evacuating device which is cleaned automatically when it is switched off. It is also an object to have a heat-evacuating device which, when it is mounted on the vehicle, does not affect the view of the operator. It is additionally an object to create a heat-evacuating device with longer working life.

A further object is to create a heat transport system with a smaller cooling medium requirement. Yet another object is to present a heat transport system that runs more quietly than previous cooling systems of the instant type.

In a first aspect, the present invention relates to a cab of the type defined above and which is characterized in that the cooling condenser projects from the wall shell, with its large faces at right angles to the wall shell. The condenser is principally disposed in this way so that the air flow through the heat-evacuating device shall not be diverted and in order to provide a simpler cleaning. Preferably, the condenser is situated in the region of the upper part of the wall shell and preferably on a rear wall of the wall shell since this region is one of the least dirty about the vehicle and the view of the operator is not disturbed (interrupted) with such a placement.

In a second aspect, the invention relates to the vehicle defined in the introduction, which is characterized in that it comprises a cab according to the invention.

In a third aspect, the invention also relates to a method for controlling a heat transport system, preferably a heat transport system comprising a heat-evacuating device according to the invention. The advantage with said method and device is that the rotation of the condenser fan is adjustable, which means that the air flow passing through the condenser at each moment corresponds to the cooling requirement of the fluid at said moment. As a result of the abovementioned coordinated fluid cooling, the fluid pressure affected by the fluid temperature can be kept at or close to a predetermined level. By virtue of the reduced variation in the fluid pressure, the stress upon the components of the heat transport system is reduced, thereby increasing their working life. By adjusting the power of the condenser fan so that it does not need to operate on constantly high power (maximum power), the noise level is also reduced and a placement on top of or on the side of the cab poses no problems for the operator of the vehicle.

### BRIEF DESCRIPTION OF THE DRAWINGS

The invention will be described below, for illustrative purposes, with reference to the accompanying drawings, in which:

FIG. 1 is a perspective view of a working machine with a cab-fitted heat-evacuating device;

FIG. 2 is an enlarged perspective view of an exposed condenser with associated condenser fans;

FIG. 3 is a side view of a working machine with a heat-evacuating device disposed on the rear wall of the cab;

FIG. 4 is a side view of an exposed cab with a the heat-evacuating device disposed on the front wall of the cab;

FIG. 5 is a side view of an exposed cab with the heat-evacuating device slightly angled relative to the horizontal plane; and

FIG. 6 is a diagrammatic representation of a closed heat transport system.

### DETAILED DESCRIPTION

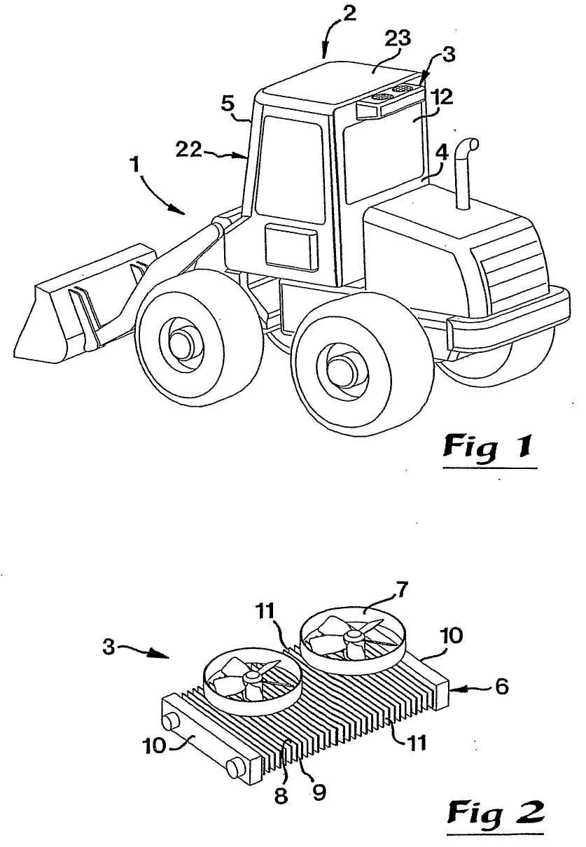

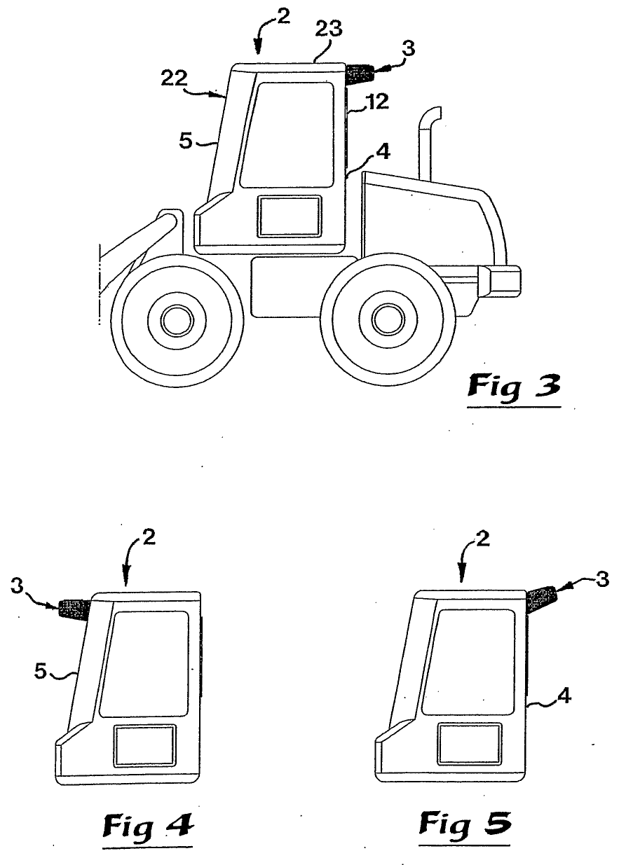

FIGS. 1 and 3 show a vehicle, denoted general by the reference numeral 1. The vehicle 1 is provided with a cab 2 on which there is placed a heat-evacuating device, generally denoted by 3. The cab 2 is preferably constituted by a driver's cab and the vehicle 1 preferably takes the form of a working machine (piece of construction equipment). It will be appreciated, however, that the cab 2 can also be intended for more persons than the driver and that the vehicle 1 can be any vehicle whatsoever with similar requirements and structure, for example a wheel-mounted loader, an excavator, a dumper, a tractor, a road grader, a front loader or the like. Cabs which are stationary or which are placed on a moving vehicle, but where the cab is only intended to control a crane arm or the like and not to control the movement of the vehicle are also to be considered included.

The cab 2 comprises a bearing wall shell 22, which extends between a floor and a roof 23 and which comprises a rear wall 4 and a front wall 5. The wall shell 22 comprises a window 12, which has a top edge located at a level below the roof 23. The rear wall 4 and front wall 5 are constituted by elements the substantially delimit the cab 2 to the rear and to the front, including in those cases in which the driver's cab 2 has a very rounded shape without clear boundaries between the walls 4, 5 and the roof and/or between the walls 4, 5 and the side walls of the cab 2. “Front” and “rear” reference those directions which the operator in the cab 2 has in front of and behind him, respectively, when operating the vehicle 1 normally.

Referring now to FIG. 2, the heat-evacuating device 3 is shown to firstly comprises a condenser 6, and secondly a fan 7 for cooling the condenser 6. As indicated in FIG. 2, the condenser 6 has a flat basic shape defined in general terms by two opposing large faces 8 and 9. Apart from the opposing large faces 8, 9, the condenser 6 has a first pair of sides 10, extending between the large faces 8 and 9 of the condenser 6, and a second pair of sides 11, extending between the large faces 8 and 9 of the condenser 6 and between the first pair of sides 10.

In the preferred embodiment shown in the drawings, the condenser fan 7 comprises two fan elements, which are placed side-by-side. For cabs 2 with smaller air-conditioning requirements, the size of the condenser 6 can, however, be reduced. The condenser fan 7 can be constituted, for example, by a fan element, which results in the heat-evacuating device 3 acquiring a more or less square shape as viewed from above in FIG. 2. Another embodiment having three or more small fan elements placed side-by-side allows the heat-evacuating device 3 to be configured such that it projects less than is shown in the appended figures. Furthermore, the condenser fan 7 is placed above the condenser 6.

To enable the heat-evacuating device 3 to have the smallest possible extent in the air-flow direction, the lower extension plane of the condenser fan 7 and the upper large face 8 of the condenser 6 are substantially parallel with one another and are situated in the immediate vicinity of one another. Preferably, the distance between these is no more than 30 millimeters, ideally no more than 25 millimeters. Furthermore, the condenser fan 7 is placed for the greater part, and preferably in its entirety, inside the region defined by a vertical projection of the sides 10, 11 of the condenser 6.

The heat-evacuating device 3, and hence the condenser 6, is placed on the wall shell 22, more precisely on the rear wall 4. Preferably, the condenser 6 is placed in the region of the upper part of the wall shell 22, the abovementioned large faces 8, 9 being horizontal and projecting at right angles to the wall shell 22. In a preferred embodiment, the heat-evacuating device 3 projects from and is fastened to the rear wall 4 of the driver's cab 2 which is located between the roof 23 and the top edge of the window 12 disposed in the rear wall 4 (see FIG. 1). Furthermore, the condenser fan 7 is situated in its entirety below the highest level of the driver's cab 2 to prevent the heat-evacuating device 3 from possibly being damaged by the surroundings of the working machine. The region on the upper part of the rear wall 4 of the driver's cab 2 is one of the least dirty regions around a working machine 1, which means that, if placed in such a way, the heat-evacuating device 3 is largely spared dirt and the like which can clog up the condenser 6 and thereby cause breakdowns. Furthermore, the heat-evacuating device 3 preferably projects less than 50 centimeters from the wall shell 22, ideally less than 47 centimeters. The extent of the heat-evacuating device 3 in the vertical direction is preferably less than 20 centimeters, and ideally less than 16 centimeters.

In a preferred embodiment (not shown), the power supply to the condenser fan 7 is electrical. The power supply can also, however, be pneumatic, hydraulic or the like, i.e. the condenser fan 7 can make use of one of the power systems present on the working machine 1.

From the flow viewpoint, the condenser fan 7 is disposed downstream of the condenser 6, i.e. the air flows in the direction from the bottom up. This is also the reason for the above-described design of the heat-evacuating device 3. One advantage of disposing the condenser fan 7 downstream of the condenser 6 is that it is more simple, at a short distance, to suck air between the tightly grouped cooling fins of the condenser 6 than to force air through the passages. Another advantage with the above-discussed design is that dirt, leaves and the like that are sucked up against the condenser 6 {or against a protective grille (not shown) situated beneath the condenser 6} and which obstruct the air flow path, fall to the ground when the condenser fan 7 is switched off or its rotation speed slows to the point where the suction force is less than the gravitational force acting upon the contaminant. Even relatively small particles which enter the heat-evacuating device 3 fall out, due to gravity, when the suction force somehow decreases, i.e. the preferred embodiment of the heat-evacuating device 3, and its placement, make it self-cleaning of dirt and the like which might disturb its functioning.

The placement also makes it easier for service personnel to service the heat-evacuating device 3 since peripheral components do not need to be dismantled in order to gain access to the heat-evacuating device 3. Cleaning with pressurized air or water can also be carried out without the need to dismantle peripheral components or the heat-evacuating device 3 itself. A further advantage of placing the heat-evacuating device 3 in the manner discussed above is that the operator of the working machine 1 automatically receives sun protection for his neck and back.

To prevent the air flow through the heat-evacuating device 3 from being adversely affected by the rest of the design of the vehicle 1, the heat-evacuating device should be located at least 15 centimeters from the nearest opposing surface on the vehicle 1.

Ideally, this distance should be at least 30 centimeters. An unwelcome diversion of the air flow is in this case precluded. In the preferred embodiment shown in the drawings, this distance is, however, about 1 meter. Placement of the heat-evacuating device 3 according to the abovementioned preferred embodiment, in which the air flow through said device 3 suffers minimal or no disruption or diversion, means that the utilization of the condenser 6 is maximized and that the dimensions of the condenser 6 can be kept to a minimum. A minimal condenser 6 (sized only to meet expected requirements without substantial excess capacity), together with the fact that it is easy to clean and is not affected by the engine-cooling system means that the quantity of fluid which acts as coolant in the heat transport system 13 is able to be reduced by about 50 percent from know arrangement.

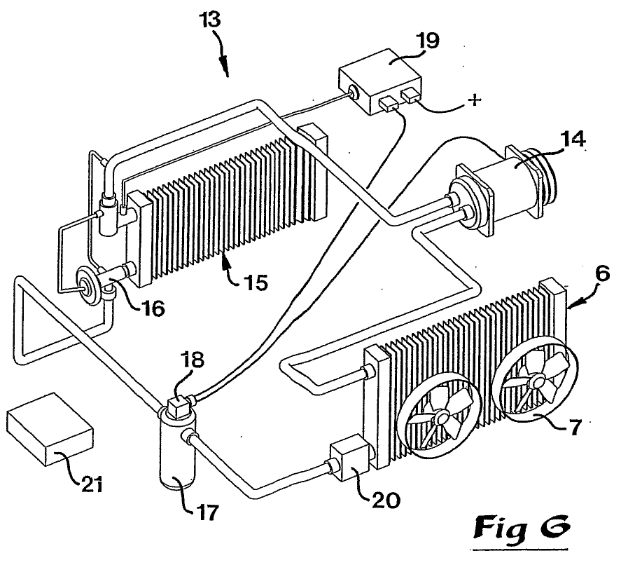

Alternative, preferred placements of the heat-evacuating device 3 are shown in FIGS. 4 and 5. FIG. 4 shows that the heat-evacuating device 3 can be placed on the front wall 5 of the cab 2 without affecting the functioning of the heat-evacuating device 3 or disturbing the view of the operator. After all, the driver's cabs 2 on working machines 1 often have some form of sun protection in the region of the upper part of the front wall 5 of the cab 2. FIG. 5 shows that the heat-evacuating device 3, regardless of where it is placed, can be angled either upward or downward relative to the horizontal plane, yet without impairing the view of the operator and without adverse effect upon the air flow.

FIG. 6 shows diagrammatically that the heat-evacuating device 3 forms part of a closed heat transport system, generally denoted by 13, which also comprises a compressor 14, an evaporator 15 and a restrictor 16. Acting in this closed system 13 is a coolant in the form of a fluid suitable for the purpose, for example the commercially available coolant “R134a”.

In a preferred embodiment, the whole of the heat transport system 13 is disposed on the side of the driver's cab 2. The advantage is that lines which convey the fluid in the heat transport system 13 do not need to be constituted by hoses which allow relative movement between the active parts of the heat transport system when these are disposed on different parts of the working machine 1, but can be constituted by solid pipes. The advantage of solid pipes, compared with hoses, is that solid pipes less frequently leak fluid as do flexible hoses. Above all, it is simpler to produce leak-tight junctions when solid pipes are used, for example by means of a weld joint.

The heat transport system 13 additionally has a first part, with a high fluid pressure, comprising the condenser 6, and a second part, with a low fluid pressure, comprising the evaporator 15. By high fluid pressure, pressures are meant that lie within the upper bracket of a predetermined pressure range. By low fluid pressure, pressures are meant which fall within the lower bracket of the same pressure range. More specifically, it can be stated that the first part begins at the pressure side of the compressor 14 and ends at the restrictor 16. Correspondingly, the second part begins at the restrictor 16 and ends at the intake side of the compressor 14.

According to conventional air-conditioning devices, the evaporator 15 is a heat-absorbing element disposed in the immediate vicinity of the space in which heat is to be absorbed by the fluid. In the preferred embodiment, the space is constituted by a cab 2 belonging to a vehicle 1. From the evaporator 15, the fluid is conducted to a pressure source, for example a compressor 14, in which the fluid is pressurized and is pumped to an exothermic element. The compressor 14 is preferably connected to and driven by a power source (not shown) belonging to the vehicle 1, for example the engine of the vehicle 1. The exothermic element or the condenser 6 release heat from the fluid into the environment; in this case, ambient atmospheric air. From the condenser 6, the fluid is conducted to the restrictor 16 which lowers the fluid pressure and which restricts the quantity of fluid which can flow into the evaporator 15 so that no more fluid than the evaporator 15 can evaporate enters the same.

Situated between the condenser 6 and the restrictor 16 is a dryer 17, which is operatively connected to the compressor 14. The task of the dryer 17 is, firstly, to act as a barrier for moisture and particle impurities which may be present in the fluid and, secondly, to act as a buffer store for the fluid. The dryer 17 is also equipped with various safety devices to protect the heat transport system 13 from damage. The dryer 17 can comprise a pressure governor 18, which detects whether the pressure in the dryer 17 is higher or lower than preset pressure limits. Should a pressure limit be exceeded, the current to the compressor 14 is switched off. If the fluid temperature increases to a level which may be harmful to the system 13 and its components, a high-pressure release valve (not shown) is triggered which is situated on top of, or on the side of the condenser 6. Another safety device in the heat transport system 13 is a thermostat 19 operatively connected to the evaporator 15. The thermostat 19 switches off the current to the compressor 14 if the temperature in the evaporator 15 falls below a certain temperature level. This level is expediently set to ensure that no ice is formed on the evaporator 15.

The heat transport system 13 also comprises means 20 for detecting the fluid pressure in the first part of the heat transport system having high fluid pressure. Preferably, this means 20 is a pressure-sensitive sensor or the like. In the preferred embodiment, the pressure sensor 20 is disposed downstream of the condenser 6 and preferably in the immediate vicinity of the condenser 6. Furthermore, the pressure sensor 20 is operatively connected to a control unit 21, which controls various operating parameters, for example the power of the condenser fan 7.

Previously, the fan which creates an air flow through the condenser was either on or off; that is, when the fan is on, it operates at a constantly high power setting (maximum power) and when it is off, it is idle. This method of intermittently controlling the fan (switching between on and off) dramatically shortens its working life. The heat transport system 13 according to the present invention is characterized in that the power of the condenser fan 7 can be varied within a bracket ranging from 0% to 100% of necessary power, by throttling of the same. When a cooling requirement arises, the condenser fan 7 operates continuously, but at a low power and only exceptionally at maximum power.

Where the condenser 6 and the condenser fan 7 are placed on top of, or on the side of a driver's cab 2, fan noise is easily transmitted to the cab 2. An unregulated condenser fan 7 that operates on maximum power when running creates annoying noise inside the driver's cab 2. With a regulated condenser fan 7, which operates predominantly on less than full power when running, this problem is minimized.

The power of the condenser fan 7 is controlled by the control unit 21 on the basis of the detected fluid pressure in the first part of the heat transport system 13. The deviation of the detected fluid pressure from a predetermined desired value is registered by the control unit 21. The power of the condenser fan 7 is controlled on the basis of the registered deviation from the desired value in order, through greater or lesser air flow through the condenser 6, to lower or raise the temperature of the fluid and hence the fluid pressure in the first part of the heat transport system 13. In order to achieve greater precision in the control of the condenser fan 7, the temperature of the ambient air can also be measured. With knowledge of this temperature, the amount of heat which the condenser can release into the ambient air, at each specific power value of the condenser fan 7, is able to be decided. The control unit 21 thus endeavors to ensure that a constant pressure is present in the heat transport system 13 and that the power of the condenser fan 7 is varied. The power of the condenser fan 7 is varied, instead of the fluid pressure of the system 13 varying, and at certain predetermined levels the condenser fan 7 is switched on or off. By controlling the condenser fan 7 in the manner described above, maximum power of the heat transport system 13 is obtained. A reduced fluid pressure spares the compressor 14 and other parts in the heat transport system 13. A more even fluid pressure, in the heat transport system 13, produces a more even fluid flow and, consequently, the restrictor 16, for example, does not need to operate as much, thereby reducing the risk of fatigue of parts active in the restrictor 16.

The use of lower power means not only that there is less wear, but also that the noise generated by the condenser fan 7 is lower. A heat transport system 13 configured according to the invention as described herein can be disposed, for example, on a vehicle 1 with a cab 2. In the event of such a placement, a low condenser fan noise is a clear advantage so as not to disturb or damage the hearing of the operator.

It should be appreciated that the invention is not limited to the embodiments described above and shown in the drawings. Both the heat-evacuating device and the heat transport system can be variously modified within the scope of the patent claims. It should specifically be mentioned that the heat-evacuating device can just as well be placed on one of the sides of the cab as on the front or rear wall of the cab, without departing from the inventive concept.

It will also be appreciated that the presently disclosed method and device for controlling a heat transport system are not confined to being used together with a heat-evacuating device, but can also be used together with heat-evacuating devices having other placements and embodiments.

What is claimed is:

1. A cab (2) for a vehicle (1), comprising:
a roof (23) supported upon a wall shell (22);
a heat-evacuating device (3) mounted upon the cab (2) and comprising a fan (7) and a condenser (6), said condenser (6) having a substantially flat shape defined between two opposing large faces (8, 9); and
said condenser (6) projecting from the wall shell (22) with the large faces (8, 9) of the condenser (6) oriented at right angles to the wall shell (22) and said condenser (6) is positioned at a location outside the cab of the vehicle that experiences substantially continuous and uniform air flow when the vehicle is underway.

2. The cab (2) as recited in claim 1, wherein the condenser (6) is disposed adjacent to an upper part of the wall shell (22).

3. The cab (2) as recited in claim 1, wherein the fan (7) is located entirely below a highest point of the cab (2).

4. The cab (2) as recited in claim 1, wherein the condenser (6) is disposed on a rear wall (4) of the wall shell (22).

5. The cab (2) as recited in claim 1, wherein the fan (7) is disposed above the condenser (6).

6. The cab (2) as recited in claim 1, wherein the fan (7) and the condenser (6) are oriented so that respective main extension planes thereof are substantially parallel with one another.

7. The cab (2) as recited in claim 1, wherein the fan (7) is disposed downstream of the condenser (6).

8. The cab (2) as recited in claim 1, wherein the fan (7) is entirely located inside a vertical projection of a first pair of sides (10) and a second pair of sides (11) of the condenser (6).

9. The cab (2) as recited in claim 1, wherein the two opposing large faces (8, 9) of the condenser (6) are disposed substantially horizontally.

10. The cab (2) as recited in claim 1, wherein the two opposing large faces (8, 9) of the condenser (6) are located at least 15 cm from the nearest opposing surface on the vehicle (1).

11. The cab (2) as recited in claim 1, wherein the heat-evacuating device (3) forms part of a closed heat transport system (13) which further comprises a compressor (14), an evaporator (15) and a restrictor (16).

12. The cab (2) as recited in claim 1, wherein said cab (2) is incorporated upon a carrying vehicle.

13. The cab (2) as recited in claim 1, wherein said cab (2) is incorporated upon a working machine.

14. A cab (2) for a vehicle (1) comprising a device for controlling a closed heat transport system (13), said system comprising:
a compressor (14), a condenser (6), a fan (7) for cooling the condenser (6), a restrictor (16) and an evaporator (15) with a thermostat (19) operatively connected to said evaporator, interacting with a fluid belonging to the heat transport system (13) and said system further comprising a first part having a high fluid pressure and including the condenser (6) and a second part having a low fluid pressure including the evaporator (15);
means (20) for detecting the fluid pressure in the first part; and
means (21) for controlling the power of the condenser fan (7) in dependence on the detected fluid pressure.

15. A cab (2) for a vehicle (1) comprising a device for controlling a closed heat transport system (13), said system comprising:
a compressor (14), a condenser (6), a fan (7) for cooling the condenser (6), a restrictor (16) and an evaporator (15) with a thermostat (19) operatively connected to said evaporator, interacting with a fluid belonging to the heat transport system (13) and said system further comprising a first part having a high fluid pressure and including the condenser (6) and a second part having a low fluid pressure including the evaporator (15);
a sensor (20) that detects the fluid pressure in the first part; and
a controller that controls power to the condenser fan (7) in dependence on the detected fluid pressure.

16. The cab (2) as recited in claim 15, further comprising means (21) for registering the deviation of the fluid pressure from a predetermined desired value and means (21) for controlling the power of the condenser fan (7) on the basis of the registered deviation from the desired value.

17. The cab (2) as recited in claim 15, wherein the sensor (20) for detecting the fluid pressure in the first part is constituted by a pressure-sensitive sensor.

18. The cab (2) as recited in claim 17, wherein the pressure sensor (20) is disposed downstream of the condenser (6).

19. The cab (2) as recited in claim 16, wherein the means (21) for registering the deviation of the fluid pressure from a predetermined desired value is constituted by a control unit (21) operatively connected to the heat transport system (13).

20. The cab (2) as recited in claim 15, wherein the means (21) for controlling the power of the condenser fan (7) is constituted by a control unit (21) operatively connected to the heat transport system (13).
